(19) United States
(12) Patent Application Publication
(10) Pub. No.: US 2002/0040955 A1
(43) Pub. Date: Apr. 11, 2002

(54) Distribution and collecting unit for forms and the use thereof

(76) Inventor: Markku Pajusuo, Vantaa (FI)

Correspondence Address: FASTH LAW OFFICES, 5255 Camelot Forest Drive, Jacksonville, FL, 32258-2516, US

(21) Appl. No.: 09/971,344

(22) Filed: Oct. 4, 2001

Related U.S. Application Data
(63) Continuation-in-part of application No. PCT/FI00/00286, filed on Apr. 3, 2000.

(30) Foreign Application Priority Data
Apr. 7, 1999 (FI) 990764

(51) Int. Cl. G07C 13/02; A47G 23/02

(52) U.S. Cl. 248/146; 235/57

(57) ABSTRACT

The distributing/collecting unit is a client feed-back of table type, wherein a little surface area is achieved for the part coming against the surface of the plane of the bottom (1) of the stand by directing the container to be upwards sloping in relation to the part coming against the surface of the plane of the bottom (1) and that the uniform stand forms the front, side and lower edges of the fixed place for forms and the front part (8) of the container forms the rear edge. The container part of the invention, is, when needed, formed by a changeable front part (8) and rear part (19). The invention directs the forms to be used therein in an upward sloping angle against a client positioned at the invention, who also from the same direction also can see the return opening (9) for these. The invention can as such and immediately without changes be used in the same rooms or be transferred to different rooms, only by, when needed, changing the forms intended to be used in it. It is, when needed, possible to see inside the container of the invention through the lid (4) of the stand without opening the lid.

### PRIOR APPLICATION

This is a continuation-in-part application of International Application No. PCT/FI00/00286 filed Apr. 3, 2000.

### TECHNICAL FIELD

The invention is concerned with a distribution and collecting unit of table type for client feed-back forms, which comprises a stand and a container to be fastened at the stand with a fastening mechanism.

### BACKGROUND AND SUMMARY OF THE INVENTION

It is known to use different kinds of collecting units for collecting client feedback forms in company rooms. The bottom area of the construction of these known distribution and collecting units for client feed-back forms has not been designed to be as small as possible because the goal has been to achieve a stable construction which is required in use. A stable construction has to withstand swinging, shaking and client use of the table very well, and that is why some side of the bottom planes is longer than the height of the distribution and collecting unit of table-type for client feed-back firms, measured from the surface of the plane or table.

The requirement of a small (as small as possible) bottom area has not been taken into consideration in the construction of the containers of known distribution and collecting units for client feedback forms. Also the volume of the known containers is over-dimensioned for the intended use, and nor has the placement of the containers in relation to the stand been taken into consideration to achieve the small bottom area. The bottom area in the solutions presented is therefore too big due to the constructions used to be placed in a practical way on the very smallest planes and tables of the business premises. They should, however, be able to be placed concretely in the middle of the service event felt by the client without restricting in any way the room, wherein the client consumes the service bought.

Known distribution and collecting units for client feed-back forms can not be placed as such on planes and tables of all sizes and forms and they are not immediately suitable without changes for all kinds of spaces by just changing the actual client feed-back forms to others, when needed. The same distribution and collecting unit for client feed-back forms can either not be used as such or be simultaneously used, for example in such an investigation, competition or election to be started in the same company, wherein different client feedback forms are used.

There are such known distribution and collecting units of table-type for client feedback forms, which, in addition to a container, have a fixed place for the client feed-back forms. The front direction of the fixed place in question, which direction decides the angle of the construction against which the client feed-back forms lie, can in the known constructions not be directed in an upwards-oblique angle to a client standing or sitting at the plane or table on which the construction is placed. In other words, in these known units, the front direction of the client feedback forms to be used is either straight upward or leaning to the side.

In the known distribution and collecting units of table type for client feedback forms it is not so that only one side of the construction, which is against the client, would expose all factors required for its use. Instead, there might, e.g., be a place for the client feedback forms to be used on the top of the construction, while different participation invitations, instructions and advertisements as well as the return opening are on one or more other sides of the construction.

Even in some of those known distribution and collecting units of table-type for client feedback forms, which, in addition to the container, has a fixed place for the client feed-back forms, the only function of the fixed place is just to be a fixed place. The possibilities offered by that place has not been utilized more extensively in order to realize it as one single construction, which at the same time, also would work as a stand of table type for the client feed-back forms, as a lid and a base for the container part and as a locking mechanism between them.

The outer color or patterning of the containers of the known distribution and collecting units of table type for client feed-back forms, which are composed of two separate parts fastened to each other by gluing or by connecting by a corresponding stationary junction, can not be easily varied, e.g., by manually releasing the parts and by changing them to parts with other colors and patterns.

The mechanism used between the stand and the container in known distribution and collecting units of table type for client feed-back forms is too slow and difficult to use, so that all the units, also those which are on the very smallest planes and tables, could be emptied and be returned to a ready-for-use state fast enough, even several times per day.

The inside of the container of known distribution and collecting units of table type for client feed-back forms can only be seen through the return opening and therefore the filling of it can not be checked fast and when needed without opening of its lid.

U.S. Pat. No. 4,029,943 discloses a polling box with a base portion and a superstructure part within said base portion. The box has a relatively big bottom area.

One object of the present invention is to present a distribution and collecting units of table type for client feed-back forms, wherein all the above mentioned disadvantages are avoided but still by maintaining a stylish appearance, which is not too dominating. Such an appearance is generally required by all useful distribution and collecting units of table type for client feedback forms. Furthermore, the construction of the invention has been developed to be as durable, stable and long lasting as possible and with a total volume which is small enough.

One object of the invention is achieved by using an integrated structure in the distribution and collecting units of table type for client feedback forms. The structure contains both a fixed place for empty client feedback forms and a container for client feedback forms left there by the clients.

The small bottom area achieved in the invention is realized by transferring the center of gravity of that place of the bottom of the stand of the construction, which place will lie against the surface of the plane, from the middle to the edge of the construction. This is done with a construction, wherein the container is directed to be upwards slanting. In such a way, all sides of the part of the invention that bears against the surface of the plane are shorter than the total height of it measured from the surface of the plane or the table, but it is very resistant against falling even in requiring use. Thanks to the construction of the invention, it fits well on even the smallest planes and tables, at which the clients consume the service they have bought, and thus it takes less room.

In accordance with the integrated construction of the invention, the stand of it consists of an integrated piece. The rails of the container are inserted and locked in the grooves at the side of said piece thus forming a space closed from the bottom side of the container. In the invention, the stand forms the front and side edges, the lower edge and the rear edge of the container of the place made for the client feedback forms. At the same time, the rear edge works as a wall at a desired angle for the client feedback forms. The client feedback forms can be directed against the rear edge in a desired angle to the client who stands or sits at the invention.

The stand and the container can be quickly attached to each other for use in a couple of seconds by means of a fast mechanism between which is easy to use. The locking tongue of the stand is pressed and drawn manually behind the container. The container of the invention is emptied in a corresponding way very fast in a couple of seconds by pressing and pushing the locking tongue of the stand in front of the container and by emptying the container.

The container to be fastened to the stand of the invention, or the two parts forming the container, which always can be refastened to each other or unfastened from each other with the fastening mechanism, can be changed to other similar parts of, e.g., different colors or with different patterns or in a way desired for example by choosing from a collection.

The solid lid of the container of the stand of the invention can also be transparent, in which case it is possible to see inside the container only by turning the invention around without opening the same.

The volume of the container corresponds in the invention each time only to the volume required by the amount of client feed-back forms to be used without extra space, whereat the total volume of the invention is as small as possible in relation to the client feed-back forms to be used in them and thus the appearance does not become too dominant. The invention can immediately be used without any changes for distribution/collecting client feedback forms on different planes and tables of the same or some other room simply by changing the actual client feed-back forms to new ones. In the invention, only the client feed-back forms alone decide the actual purpose of use, which, e.g., can be distribution/collecting material for an investigation, competition or election to be performed, e.g., with client feed-back forms, without any stuff that otherwise would be needed to take care of that.

The directing of the invention is also facilitated in such a way that the longitudinal direction of the container has the form of a parallelogram, whereby the client can immediately see, at the same time, from the front side directed against him, both the place for the client feed-back forms and the return opening without turning it around. Furthermore, the invention can easily be moved between all kinds of different planes, even with two fingers, and each time be positioned to the optimal front direction on the desired plane.

### BRIEF DESCRIPTION OF THE DRAWINGS

In the following the invention is described more in detail by referring to the enclosed drawing, which illustrates the construction of the distribution/collecting unit of the invention of table type for client feedback forms, wherein

FIG. 1 presents the integrated construction of the distribution/collecting unit of the invention of table type for client feed-back forms brought in a form ready for use, in which its stand and container have been attached to each other,

FIG. 2 presents the construction of the stand of the distribution/collecting unit of the invention of table type for client feedback forms,

FIG. 3 presents the whole construction of the container of the distribution/collecting unit of the invention of table type for client feedback forms seen in the direction of its open lower side,

FIG. 4 presents the fastening mechanism, which can be opened, between the front and rear parts of the container of the distribution/collecting unit of the invention of table type for client feedback forms

FIG. 5 presents the part of the container of the distribution/collecting unit of the invention of table type for client feedback forms, which can be seen from the other corner of its open lower side.

### DETAILED DESCRIPTION

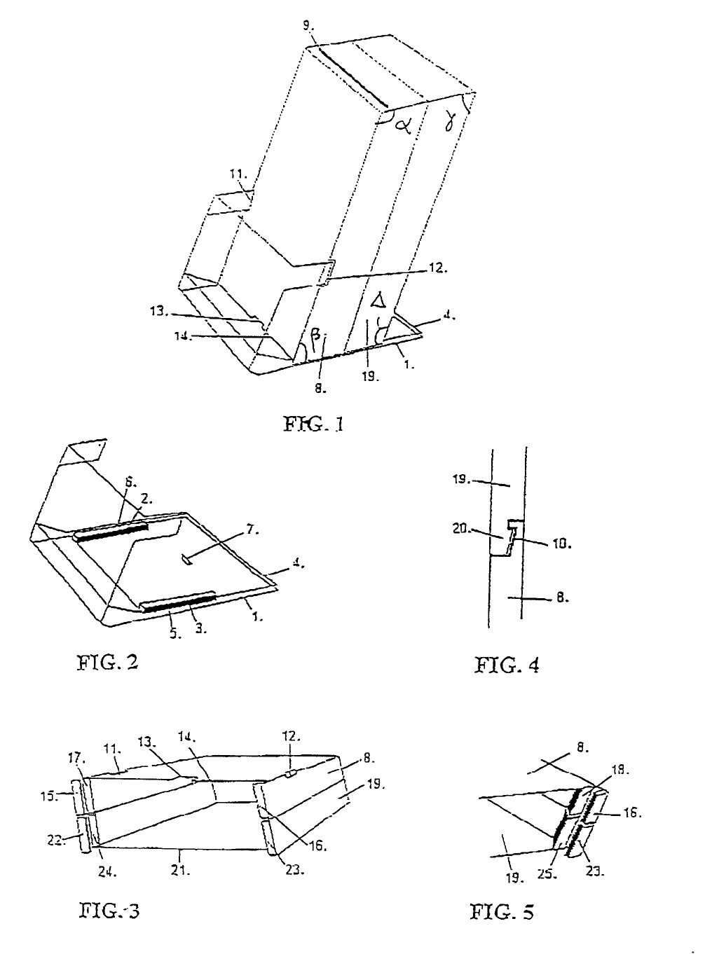

The distribution/collecting unit of the invention of table type for client feedback forms (FIG. 1 consists of two parts to be integrally attached to each other, i.e., a stand (FIG. 2) and a container (FIG. 3).

In FIG. 2, the bottom part 1 of the stand of the invention is in this example manufactured of transparent polystyrene with a thickness of 2 mm. In this example, the bottom part is manufactured of a uniform T-shaped piece with a length of 17 cm, and with a breadth of 10.80 cm until the length of 13.80 cm and with a maximal breadth of 16.70 cm at the T-extrusions. The T-extrusions that broaden the piece are rising in a 15° angle with an upward inclination. The first 10 cm from the thinnest end of the T-shaped piece form the area of the construction of the stand which comes against the surface of the plane, after which the piece is bent in the transversal direction over its entire breadth 105° up and backwards, thus forming the front part of the place of the construction of the stand for client feed-back forms. The T-extrusions are bent 90° inwards over its entire breadth and they form the side parts of the place for the client feedback forms of the construction of the stand.

In the example, the area lying against the plane or table of the bottom part 1 is 108 cm² and above that, on its both 10 cm sides, between 2,5 cm and 7 cm, bars 2 and 3 with a length of 4.50 cm, a thickness of 4 mm and a breadth of 6 mm have been glued over its entire length on a distance of 6 mm from its side edges. A lid 4 of transparent polystyrene with a length of 10 cm and a breadth of 10.6 cm, for the container, has been glued on the bars 2 and 3. The lid 4 has been bent from its front part at 2.5 cm in its transversal direction over its entire length 15° upwards thereby forming a bottom with a desired angle for the client feedback forms to be used. The lid is glued on the bars 2 and 3 so that its bent front end is fastened in an angle of 90° against the inner surface of the place for the client feedback forms and the lid is concentrated on the part that is against the surface of the plane. The place which is against the surface of the plane of the bottom part 1, the bars 2 and 3 and the lid 4 form rail tracks 5 and 6 when they are fastened together on both sides of the stand. A locking tongue 7 has been glued on the lid 4 of the stand. The locking tongue 7 locks the container part in a desired angle to the stand.

In FIG. 3, the front part 8 of the container of the invention is in the example an extruded plastic part, which is 17.5 cm high, 11.5 cm wide and 2.8 cm deep and with a thickness of 3 mm. The inner side of the upper end, which is compact except at the return opening 9 of the client feedback forms, opens in an 105° angle and the edges of the lower open end are in a 75° angle. A fastening track 10 extends along the longitudinal edge parts of the front part 8 for the manual fastening of parts 8 and 19. The outer side of the front part 8, which works as the rear part of the place for the client feed-back forms, contains recesses 11 and 12 of 3 mm for both T-extrusions of the stand. On the long side of the lower end of the front part 8, there is both a cut 13 that extends through the locking tongue 7 of the stand and a cut 14 that over its entire side extends through both bars 2 and 3 and the lid 4 of the stand. On both edges of the lower end of the front part, there are rails 15 and 16 over the entire depth and guide means 17 and 18 for the client feed-back forms, which fit in the rail tracks 5 and 6 so that the rails 15 and 16 with four sides (FIG. 5) extend between the rail tracks 5 and 6 of the stand and the guide means 17 and 18 with three sides (FIG. 5) extend above them.

The rear part 19 of the wall/container is an extruded plastic part, which is 17.5 cm high, 11.5 cm wide and 2.8 cm deep and with a thickness of 3 mm. The compact upper end, opens in a 75° angle and the edges of the lower open end are in a 105° angle. A fastener track 20 extends along the longitudinal edge parts of the rear part 19 for the manual attachment of parts 8 and 19. On the longitudinal side of the lower end of the rear part, there is a cut 21 extending through the lid 4 of the stand and both rods 2 and 3. There are rails 22 and 23 extending along the entire depth on both edges of the lower end of the rear part and guide means 24 and 25 for the client feed-back forms, which guide means fit in the rail tracks of the stand so that the rails 22 and 23 having four sides (FIG. 5) extend between the rail tracks 5 and 6 of the stand and the guide means 24 and 25 with three sides (FIG. 5) extend above them.

In the example, the container part becomes ready for use by placing the fastening track 10, the detailed construction of which was described above, and the fastener track 20 of the rear part against each other and by pressing them manually together so that they become attached to each other (FIG. 4).

In FIG. 1, the final integrated construction of the invention, which is easy and fast to use, is made ready by pushing the rails 15, 16, 22 and 23 of the usable container with the front part 8 first in the rail tracks 5 and 6 of the stand and by pressing the rear edge of the lid 4 against the bottom 1 from behind the locking tongue 7 and by drawing the stand until the locking tongue 7 is transferred through the cut 14 behind the rear part 109 of the container and until the construction is locked by releasing the pressing. According to the invention, the client feed-back forms dropped inside its container can be quickly emptied by pressing the rear edge of the lid 4 against the bottom part 1 from behind the locking tongue 7 and by pushing the stand until the locking tongue is transferred through the cut 14 in front of the rear part 19 of the container and by drawing the rails 15, 16, 22 and 23 of the container free from the rail tracks 5 and 6 of the stand, whereat all the client feed-back forms inside the invention can be emptied from it.

For one skilled in the art, it is clear that different solutions than the one described above can exist in the scope of the invention, and they can vary in scope of the claims described below. Thus, the stand and the container of the invention can even entirely be manufactured of some other material than tree, metal, cartoon, laminate or glass. The angle or size of the presented place for the client feed-back forms can be changed when needed by transferring the effect of the change to be realized to other dimensions of the construction of the invention. In the invention, the attachment between the stand and the container can also be realized with other fastening means and the attachment between the front part 8 and the rear part 9 can also be realized with a fastening means that can be completely opened, it can be completely stationary or partly stationary by connecting the parts together, only from one side or from the end.

The weight of the forms to be put in the stand can be even bigger than the weight of the stand itself, whereby moving of the forms has to be minimized outside the container as well as inside the container. As in the invention the forms lean against the container (which is not the case if the container would be in a 90 degree angle) they do not move from one edge of the container to another which would make the stand unstable. The upwardly sloping angle of the container causes that the tongue (7) can be put more backwards as the rear edge (21) of the container is on the stand more backwards than if the container would be straight upward in a 90 degree angle. The bars 2, 3 required for the locking mechanism can be longer and thus the total construction is stronger.

It is essential that both the front part and the rear part of the container are upwardly sloping and thus also the forms to be used in the stand are in the same upwardly sloping angle, both those forms that are outside the stand and those which are inside the stand, whereby the weight of the form is also transferred backwardly.

The feature that all the forms are leaning on the rear wall of the container inside the container also causes that the return opening in the container is open longer because the forms that already are inside the container are not in the way when new forms are put in.

The above fact also has the consequence that the container can have a smaller size. There is no need to make it bigger than is required by the forms. The upwardly sloping angle of the container is also advantageous in that the forms can be directed against the face of the client that is sitting at the table. The height of the container can always be bigger than the stand part or the cross dimension of the bottom of the stand.

The drawings and the special part that are connected to that are only meant to illustrate the invention. The other details of the invention, as for example the stand and its constructions and the container and the aforementioned applications between the parts can vary in the scope of the claims.

1. A distribution/collecting unit for forms, comprising a container and a stand which supports the container, wherein the container is fastened on the stand, characterized in that, the container and the stand work as an integrated construction by forming two fixed places for forms in the distribution/collecting unit, the first fixed place consisting of the container, whereas the front and the side edges of the second fixed place is formed by the stand and the rear edge of the second fixed place is formed by the front part (8) of the container, in order to utilize the stand more extensively to make a smaller construction and in that the rear edge of the fixed place formed by the front part (8) of the container works at the same time as a wall for the forms in an angle that is sloping so that a rear part (19) of the container is also in an angle that is sloping.

2. The distribution/collecting unit for forms of claim 1, characterized in that, the stand also works as a lid (4) for the container, which can be opened.

3. The distribution/collecting unit for forms of claim 1, characterized in that the container is directed upwardly in relation to the plane of the stand so that the center of gravity of the unit is on the rear part of the stand to achieve a small bottom area.

4. The distribution/collecting unit for forms of claim 1, characterized in that the stand is formed by a bottom part (1), bars (2 and 3), a lid (4) and a locking tongue (7), whereat the stand at the same time works both as a lid for the container and a locking mechanism between the stand and the container.

5. The distribution/collecting unit for forms of claim 1, characterized in that there is a return opening (9) for forms in the front part (8) of the container.

6. The distribution/collecting unit for forms of claim 1, characterized in that the front part (8) of the container has a fastening track (10), recessions (11 and 12), cuts (13), cuts (14), rails (15 and 16) as well as guide means (24 and 25) to attach the container to the stand.

7. The distribution/collecting unit for forms of claim 6, characterized in that the stand and the container can be attached to each other and released from each other with a locking mechanism by pushing the rails (15, 16, 22 and 23) of the container with the front part (8) first to the rail tracks (5 and 6) of the stand and by pressing the bottom part (1) against the rear edge of the lid (4) from behind the locking tongue (7) and by drawing the stand until the locking tongue (7) is transferred through the cut (14) behind the rear part (19) of the container and the construction is locked by releasing the pressing and vice versa.

8. The distribution/collecting unit for forms of claim 7, characterized in that the front part (8) and the rear part (19) of the container can always be fastened to each other again and be released from each other with a fastening mechanism.

9. The distribution/collecting unit for forms of claim 7, characterized in that the front part (8) and the rear part (19) of the container can be changed to other front parts (8) and rear parts (19) of different colors and patterns.

10. The distribution/collecting unit for forms of claim 4, characterized in that, the lid (4) of the stand can either be chosen to be transparent, whereat it is possible to see inside the container from the bottom without opening the locking mechanism between the container and the stand or non-transparent, whereat it is not possible to see inside the container from the bottom without opening the locking mechanism between the container and the stand.

11. The distribution/collecting unit for forms of claim 5, characterized in that, the container of the unit has the form of a parallelogram with respect to its length direction, which means that both the second fixed place for the forms and the return opening (9) for the first place, all the walls of which is formed by the container, can be seen at the same time by just looking perpendicularly against the front part (8).
